(19) United States
(12) Patent Application Publication
(10) Pub. No.: US 2018/0032499 A1
(43) Pub. Date: Feb. 1, 2018

(54) Automatically Generating Spelling Suggestions and Corrections Based on User Context

(71) Applicant: Google Inc., Mountain View, CA (US)

(72) Inventors: Courtney Hampson, Sunnyvale, CA (US); Jason Sanio, Sunnyvale, CA (US)

(21) Appl. No.: 15/222,864

(22) Filed: Jul. 28, 2016

(51) Int. Cl. G06F 17/27; H04W 4/02; G06K 9/46; G06F 17/22

(52) U.S. Cl. CPC G06F 17/273; G06F 17/274; G06F 17/2211; H04W 4/025; G06K 9/4671

(57) ABSTRACT

Methods and systems for automatically generating spelling suggestions and corrections are described. The method includes receiving content being shared by a user, determining a first language associated with the content, determining a context for the content, determining a potential error in the content using the first language and the context, and providing an identification of the potential error to the user. The methods may further include determining a correction for the potential error based on the first language and the context; and providing the correction to the user in the content in place of the potential error and with the identification.

### BACKGROUND

Existing correction applications suffer from certain technical problems. Specifically, existing correction applications compare data input, such as a text message, to a standard database or dictionary in a language predetermined by the user in order to determine if an error is present in the input. In some examples, the existing correction applications are able to also provide a correction for the error based on identifying similar content within the standard database in the user's language. Existing correction applications are limited to the language of the user and the contents of the standard database to determine if an error is present and provide a correction.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

This specification relates to systems and methods for automatically generating spelling suggestions and corrections based on user context. According to one aspect of the subject matter described in this disclosure, a system includes one or more processors, and one or more memories storing instructions that, when executed by the one or more processors, cause the system to perform operations including: receiving content being shared by a user, determining a first language associated with the content, determining a context for the content, determining a potential error in the content using the first language and the context, and providing an identification of the potential error to the user.

In general another aspect of the subject matter described in this disclosure includes a method that includes receiving content being shared by a user, determining a first language associated with the content, determining a context for the content, determining a potential error in the content using the first language and the context, and providing an identification of the potential error to the user.

Other implementations of one or more of these aspects include corresponding systems, apparatus, and computer programs, configured to perform the actions of the methods, encoded on computer storage devices.

These and other implementations may each optionally include one or more of the following features. For instance, the operations may further include comparing the content to a first database for the first language to identify a language error in the content based on the comparison, and comparing the language error to a context database to confirm that the language error is the potential error. In another instance, the operations may further include determining a correction for the potential error based on the first language and the context, and providing the correction to the user in the content in place of the potential error and with the identification. In another instance, the operations may further include determining that the correction provided to the user has been selected, and updating the first database to include the correction.

In general, another aspect of the subject matter disclosed in this disclosure may be embodied in methods that include determining a location of the user device used to share the content, determining a second language associated with the location of the user device, comparing the content to a first database for the first language and identifying a language error in the content based on the comparison, comparing the language error to a second database for the second language and confirming that the language error is also a context error based on the comparison, and wherein providing the identification of the potential error identifies the language error as the potential error responsive to confirming that the language error is also the context error. In another aspect, the methods may include determining an object from the image in the content, and comparing the object to a database of objects to determine the context. In another aspect, the methods may include determining a future context based on signals received from the user device, preloading a potential suggestion from the context database and based on the future context to the user device, and providing the potential suggestion to the user in response to receiving future content.

### BRIEF DESCRIPTION OF THE DRAWINGS

The specification is illustrated by way of example, and not by way of limitation in the figures of the accompanying drawings in which like reference numerals are used to refer to similar elements.

FIG. 1 is a block diagram illustrating an example system for automatically generating spelling suggestions and corrections.

FIG. 2A is a block diagram illustrating an example server including an context based autocorrection application.

FIG. 2B is a block diagram illustrating an example computing device including the context based autocorrection application.

FIG. 2C is a block diagram illustrating an example context module.

FIG. 2D is a block diagram illustrating an example database library module.

FIG. 3A is a flowchart illustrating an example method for automatically generating spelling suggestions and corrections.

FIG. 3B is a flowchart illustrating an example method for receiving content form a user.

FIG. 3C is a flowchart illustrating an example method for determining a context of content.

FIGS. 4A-4B are another example method for providing a suggested correction to the user.

FIG. 5 is an example method for processing an image to determine context or objects.

FIG. 6 is an example method automatically generating spelling suggestions and corrections using location and context.

FIGS. 7-9 are graphical representations illustrating an example user interface for providing a suggested correction for a text message.

### DETAILED DESCRIPTION

Existing correction applications suffer from certain technical problems that have been identified above. More specifically, existing correction applications often produce too many false positives (e.g., identification of text as errors when in fact they are not errors). This is because existing correction applications perform simple comparisons between data input, such as a text message, to a standard dictionary. In some implementations, a computer system and a computer-executed method are provided that include a technical solution to the technical problem of reducing the number of false positives that existing correction and suggestion systems generate. The technical solution includes determining context of content and based on the context, selecting a context specific database to use for error correction and suggestion generation. The context may include location, language, profile information, calendar information, search history information, communication type, or any combination of the foregoing.

This specification describes a computer system and computer-executed method that automatically generates spelling suggestions and corrections based on user context. This system and method are particularly advantageous because by using context in the identification of errors and generation of suggestions, the number of falsely identified errors is greatly reduced. This improves the user experience and interaction with the computing device, and provides an interface with increased efficiency and usability.

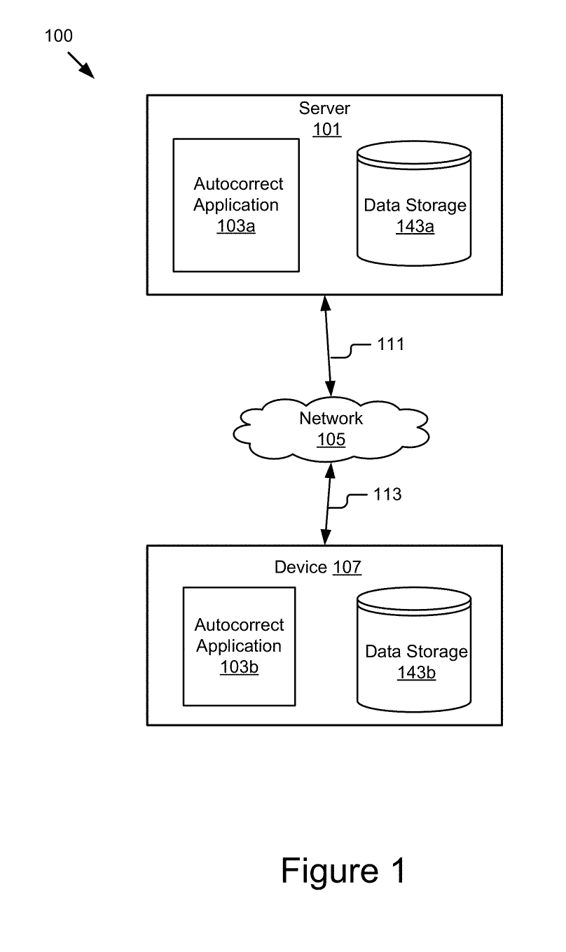

FIG. 1 illustrates a block diagram of an example system 100 that automatically generates spelling suggestions and corrections based on user context. In some implementations, the system 100 comprises a server 101, a network 105 and a device 107. The system 100 may include a server 101 for providing spelling suggestions or corrections. The system 100 as illustrated has a device 107 typically utilized by a user to access servers hosting websites via networks. In the illustrated example, these entities are communicatively coupled via a network 105.

It should be recognized that in FIG. 1 as well as other figures used to illustrate the technology, an indication of a letter after a reference number or numeral, for example, “143a” is a specific reference to the element or component that is designated by that particular reference numeral. In the event a reference numeral appears in the text without a letter following it, for example, “143,” it should be recognized that such is a general reference to different implementations of the element or component bearing that general reference numeral. Moreover, though only one device 107 is illustrated in FIG. 1 by way of example, it should be recognized that any number of devices 107 may be used by any number of users in other system architectures.

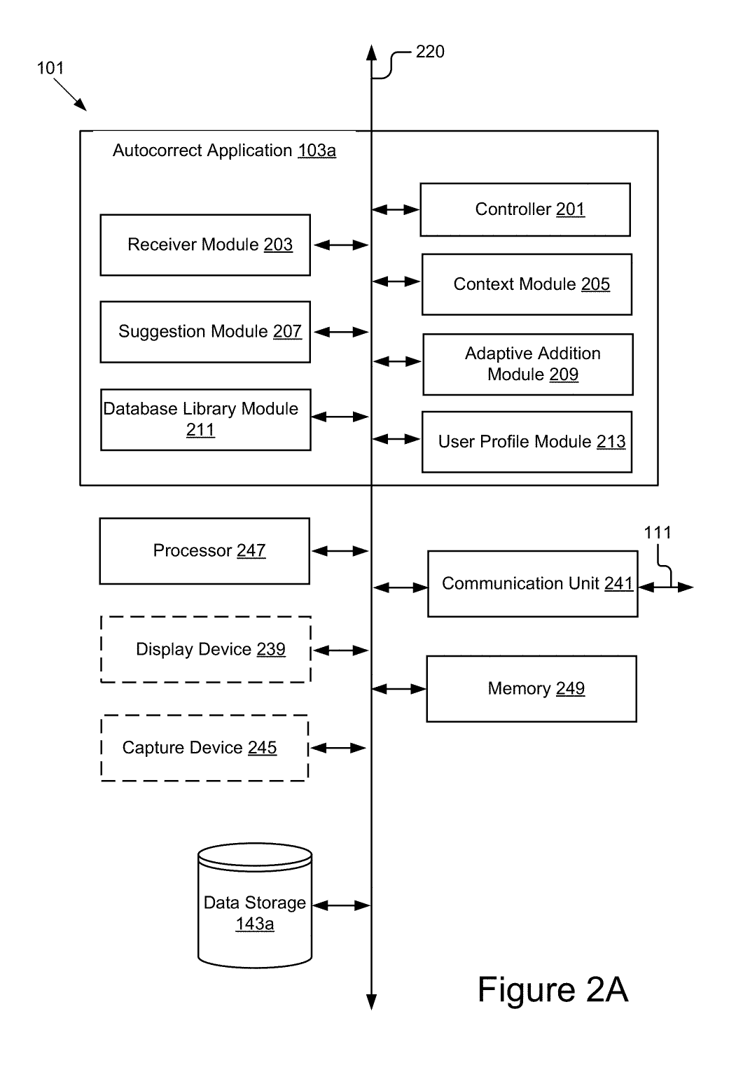

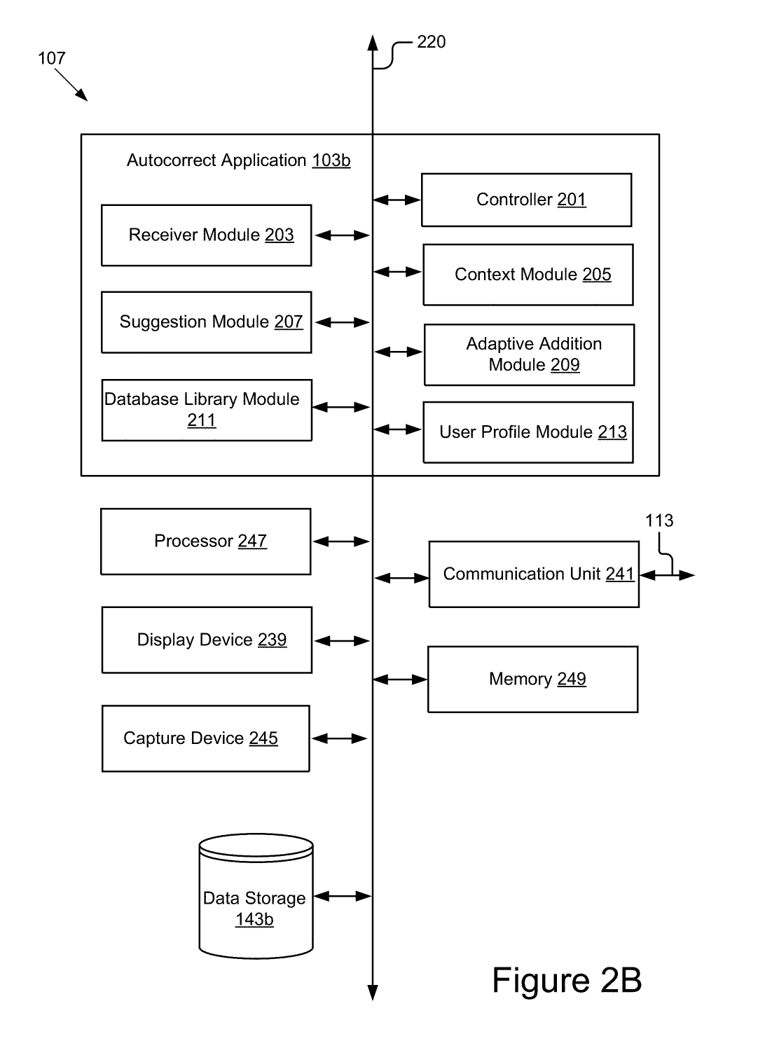

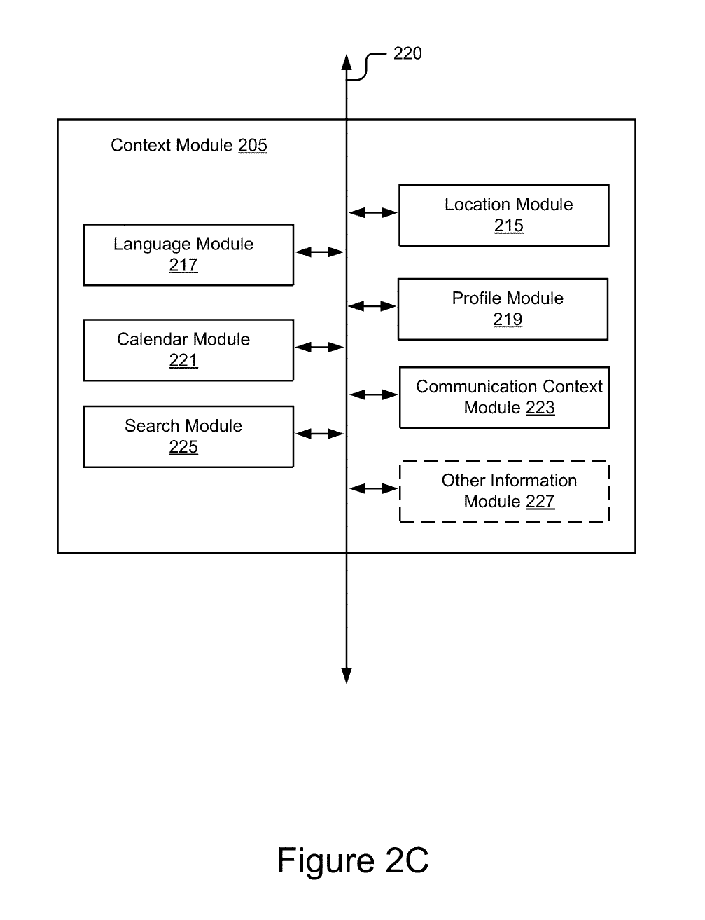

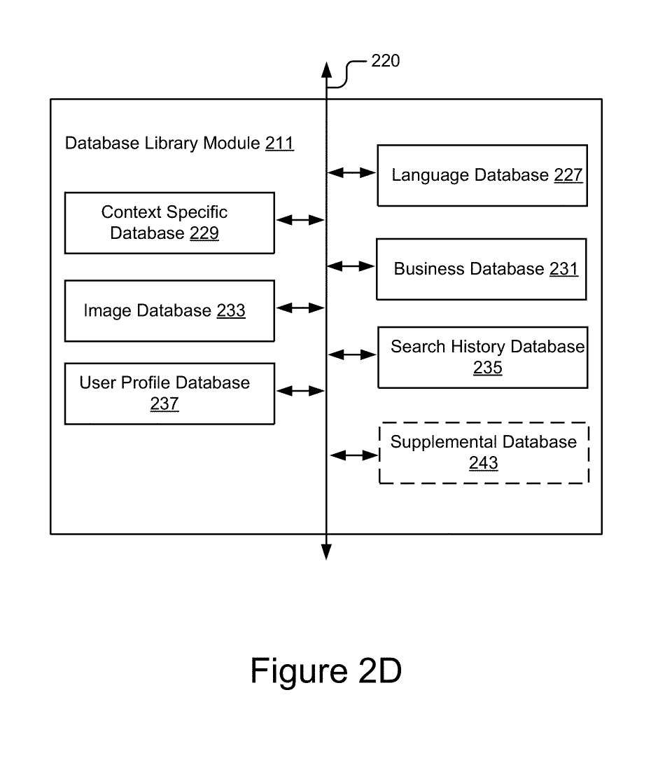

In some implementations, the server 101 may be, or may be implemented by, a computing device including a processor, a memory, applications, a database, and network capabilities. In the example of FIG. 1, the server 101 includes an autocorrect application 103a that will be described in detail below. One implementation for the server 101 is described below with reference to FIG. 2A. In some implementations, the server 101 sends and receives data to and from other entities of the system 100 via the network 105. For example, the server 101 sends and receives data, including content being shared, to and from the device 107. Although only a single server 101 is shown in FIG. 1, it should be understood that there may be any number of servers 101 or a server cluster. The server 101 may also include a data storage 143a, which is described in more detail below.

In some implementations, the device 107 can be any computing device that includes a memory, a processor and communication capabilities. For example, the device 107 can be a laptop computer, a desktop computer, a tablet computer, a mobile telephone, a personal digital assistant, a mobile email device, a portable game player, a portable music player, a television with one or more processors embedded therein or coupled thereto or any other electronic device capable of accessing the network 105, etc. The device 107 may provide graphics and multimedia processing for any type of application. The device 107 may include a display for viewing information provided by the server 101. In some implementations, the device 107 may include an autocorrect application 103b and/or data storage 143b, described in more detail below.

In some implementations, the device 107 and/or the server 101 comprise an autocorrect application 103 for providing automatic generating spelling suggestions and corrections. In one implementation, the autocorrect application 103 is part of a communication application and processes communications before they are sent from either the device 107 or the server 101. In another implementation, the autocorrect application 103 is operational in the background on the either the device 107 or the server 101 and provides suggestions or corrections for messages before they are sent. As one example, the user may input using the device 107 an item of content to share with another user. The autocorrect application 103b may receive the content and determine a suggested correction within the content by comparing the content to a database stored in data storage 143b. Further acts and/or functionalities of the autocorrect application 103 are described in further detail below with respect to FIGS. 2A-2C.

The autocorrect application 103 may include steps, processes, functionalities or a device for performing them, to provide the functionality for automatic generating spelling suggestions and corrections. In some implementations, the autocorrect application 103 may be implemented using programmable or specialized hardware, such as a field programmable gate array (FPGA) or an application-specific integrated circuit (ASIC). In some implementations, the autocorrect application 103 acts as a thin-client application with some functionality executed on the device 107 by autocorrect application 103b and additional functionality executed on the server 101 by autocorrect application 103a. For example, the autocorrect application 103b on the device 107 could include steps, processes, functionalities, or a device for performing them and/or logic for receiving instructions to share content and/or identify potential errors in the content to be shared. The autocorrect application 103a on the server 101 could include steps, processes, functionalities or a device for performing them and/or logic for determining a context and/or a suggested correction related to the content being shared. A thin-client application may include further functionality described herein with reference to autocorrect application 103.

In some implementations, the autocorrect application 103 requires that the user consent to allow the autocorrect application 103 and/or other components discussed elsewhere herein to process information related to the user. If the user fails to consent, the autocorrect application 103 does not process any information related to the user.

The network 105 may be a conventional type, wired or wireless, and may have numerous different configurations including a star configuration, token ring configuration or other configurations. Furthermore, the network 105 may include a local area network (LAN), a wide area network (WAN) (e.g., the Internet), and/or other interconnected data paths across which multiple devices may communicate. In some implementations, the network 105 may be a peer-to-peer network. The network 105 may also be coupled to or include portions of a telecommunications network for sending data in a variety of different communication protocols. In some other implementations, the network 105 includes Bluetooth® communication networks or a cellular communications network for sending and receiving data including via short messaging service (SMS), multimedia messaging service (MMS), hypertext transfer protocol (HTTP), direct data connection, wireless application protocol (WAP), email, etc. In addition, although FIG. 1 illustrates a single network 105 coupled to the device 107 and the server 101, in practice, one or more networks 105 may be connected to these entities.

The data storage 143 is an information source for storing and providing access to data. The device 107 and/or server 101 may include the data storage 143 and/or provide access to the data storage 143 via the network 105. The data storage 143 may be configured to store databases for providing automatically generating spelling suggestions and corrections. Further acts and/or functionalities of the data storage 143 are described in further detail below with respect to at least FIG. 2.

FIG. 2A is a block diagram of an example server 101. As depicted, the example server 101 may include a processor 247, a communication unit 241, a display device 239, a memory 249, a capture device 245, a data storage 143a, and an autocorrect application 103a, which may be communicatively coupled by a communication bus 220. The display device 239 and the capture device 245 are shown with dashed lines to indicate they are optional.

The processor 247 may execute steps, processes, functionalities, or routines. The processor 247 may have various computing architectures to manage data signals including, for example, a complex instruction set computer (CISC) architecture, a reduced instruction set computer (RISC) architecture, and/or an architecture implementing a combination of instruction sets. The processor 247 may be physical and/or virtual, and may include a single core or plurality of processing units and/or cores. In some implementations, the processor 247 may be capable of generating and providing electronic display signals to a display device 239, supporting the display of images, capturing content using the capture device 245, transmitting and receiving messages, images, and video. In some implementations, the processor 247 may be coupled to the memory 249 via the bus 220 to access data and instructions therefrom and store data therein. The bus 220 may couple the processor 247 to the other components including, for example, the memory 249, communication unit 241, and the data storage 143.

The memory 249 may store and provide access to data to the other components. In some implementations, the memory 249 may store instructions and/or data that may be executed by the processor 247. The memory 249 is also capable of storing other instructions and data, including, for example, an operating system, hardware drivers, other computer-executed applications, databases, etc. The memory 249 may be coupled to the bus 220 for communication with the processor 247 and the other components.

The memory 249 may include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with the processor 247. In some implementations, the memory 249 may include one or more of volatile memory and non-volatile memory (e.g., RAM, ROM, hard disk, optical disk, etc.). It should be understood that the memory 249 may be a single device or may include multiple types of devices and configurations.

The bus 220 can include a communication bus for transferring data between components of a computing device or between computing devices, a network bus system including the network 105 or portions thereof, a processor mesh, a combination thereof, etc. In some implementations, the autocorrect application 103 and the other components of the server 101 and/or device 107 may cooperate and communicate via a software communication mechanism implemented in association with the bus 220. The software communication mechanism can include and/or facilitate, for example, inter-process communication, local function or procedure calls, remote procedure calls, network-based communication, secure communication, etc.

The communication unit 241 may include one or more interface devices for wired and wireless connectivity with the network 105 and the other entities and/or components of the system 100 including, for example, the device 107, and the server 101, etc. For instance, the communication unit 241 may include, but is not limited to, Category 5 cable (CATS)-type interfaces; wireless transceivers for sending and receiving signals using a wireless local area network (WLAN or Wi-Fi); Bluetooth®, cellular communications, etc.; universal serial bus (USB) interfaces; various combinations thereof; etc. The communication unit 241 may be coupled to the network 105 via signal lines 111 or 113. In some implementations, the communication unit 241 can link the processor 247 to the network 105, which may in turn be coupled to other processing systems. The communication unit 241 can provide other connections to the network 105 and to other entities of the system 100 using various communication protocols, including, for example, those discussed elsewhere herein.

The data storage 143 is an information source for storing and providing access to data. In some implementations, the data storage 143 may be coupled to the components 247, 241, 239, 249, 245, and/or 103 of the server 101 and/or the device 107 via the bus 220 to receive and provide access to data. In some implementations, the data storage 143 may store data received from the autocorrect application 103, and/or provide the autocorrect application 103 access to the stored data. The data storage 143 can include one or more non-transitory computer-readable media for storing the data. In some implementations, the data storage 143 may be incorporated with the memory 249 or may be distinct therefrom. In some implementations, the data storage 143 may include a database management system (DBMS). For example, the DBMS could include a structured query language (SQL) DBMS, a NoSQL DBMS, various combinations thereof, etc. In some instances, the DBMS may store data in multi-dimensional tables comprised of rows and columns, and manipulate, e.g., insert, query, update and/or delete, rows of data using programmatic operations. In some implementations, the data storage 143 may store various databases for use in the process of providing automatic generating spelling suggestions and corrections.

The display device 239 may be a screen or other device for displaying content and corrections using a user interface. The display device 239 may be configured to connect to the processor 247 and data storage 143 via the bus 220 and receive information from the autocorrect application 103. The display device 239 may be incorporated into a mobile phone, tablet, computer, camera, or other device capable of being configured with a display screen.

The capture device 245 may be a device capable of capturing content. The capture device 245 may be any device capable of capturing data, including a camera, a video capture device, a microphone, a keyboard, a mouse, or similar device. The capture device 245 may be a stand-alone device or configured to be part of the server 101 and/or device 107. The capture device 245 may be configured to connect to the processor 247 and data storage 143 via the bus 220, to receive and send information from the autocorrect application 103.

As depicted in FIGS. 2A and 2B, the autocorrect application 103 includes a controller 201, a receiver module 203, a context module 205, a suggestion module 207, an adaptive addition module 209, a database library module 211, and a user profile module 213. The components 201, 203, 205, 207, 209, 211, and 213 of the autocorrect application 103 are coupled for communication with each other and the other components 247, 241, 239, 249, 245, and 143 by the bus 220. The components 201, 203, 205, 207, 209, 211, and 213 are also coupled to the network 105 via the communication unit 241 for communication with the other entities of the system 100.

In some implementations, the controller 201, the receiver module 203, the context module 205, the suggestion module 207, the adaptive addition module 209, the database library module 211, and the user profile module 213 are sets of instructions executable by the processor 247 to provide their respective acts and/or functionality. In other implementations, the controller 201, the receiver module 203, the context module 205, the suggestion module 207, the adaptive addition module 209, the database library module 211, and the user profile module 213 are stored in the memory 249 and are accessible and executable by the processor 247 to provide their respective acts and/or functionality. In any of these implementations, the controller 201, the receiver module 203, the context module 205, the suggestion module 207, the adaptive addition module 209, the database library module 211, and the user profile module 213 may be adapted for cooperation and communication with the processor 247 and other components 241, 239, 249, 245, and 143 of the server 101 or the device 107.

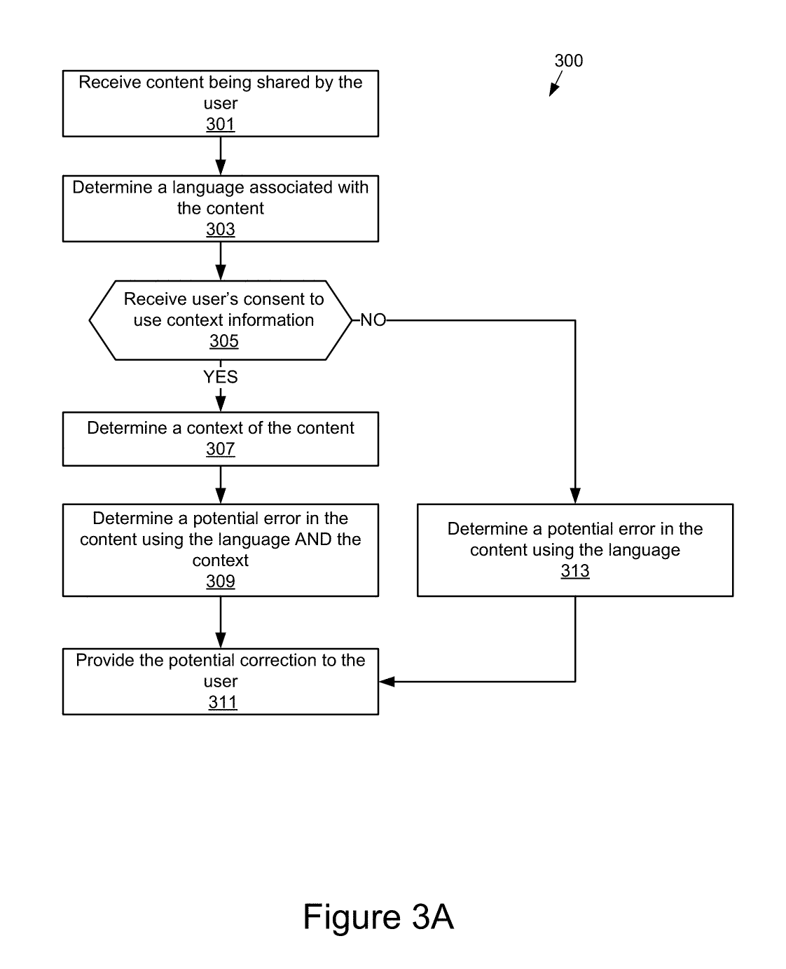

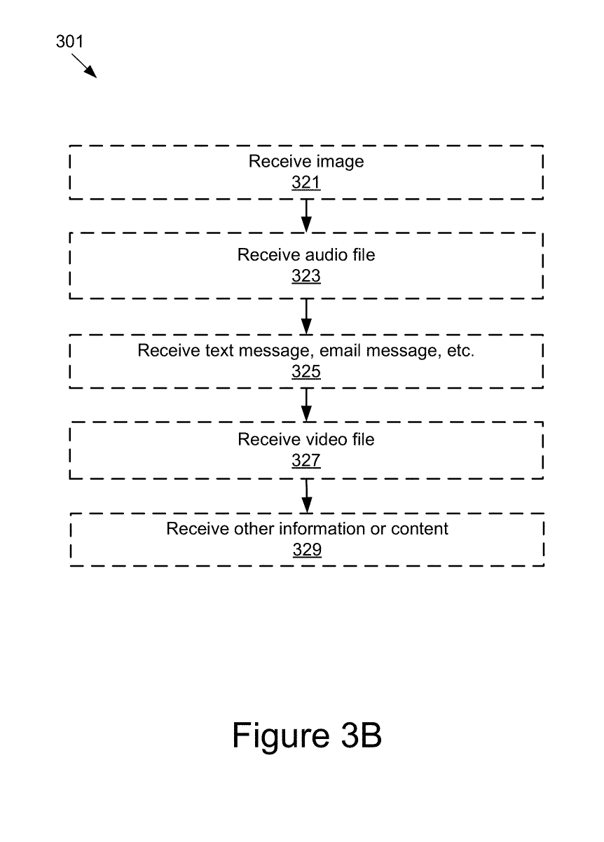

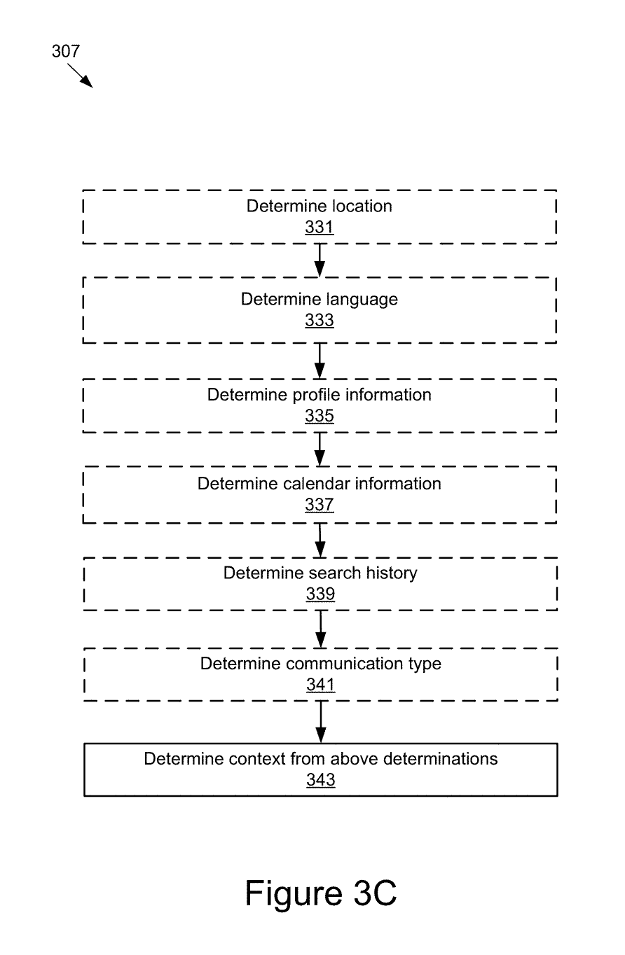

The controller 201 may be steps, processes, functionalities or a device to control the operation of the other components of the autocorrect application 103. The controller 201 controls the other components of the autocorrect application 103 to perform the methods described below with reference to FIGS. 3A-9. The controller 201 may also include steps, processes, functionalities or a device for handling communications between the autocorrect application 103 and other components, as well as between the components of the autocorrect application 103. In some implementations, the controller 201 may be adapted for cooperation and communication with the processor 247, the memory 249, and other components of the autocorrect application via the bus 220.

In some implementations, the controller 201 sends and receives data, via the communication unit 241, to and from one or more of the device 107 and the server 101. For example, the controller 201 receives, via the communication unit 241, content from the device 107 operated by a user and sends the content to the receiver module 203, the context module 205, or the suggestion module 207. In another example, the controller 201 receives a suggested correction from the suggestion module 207 and sends the suggestion to the device 107, causing the device 107 to present the suggested correction to the user using the display device 239.

In some implementations, the controller 201 receives data from other components of the autocorrect application 103 and stores the data in the data storage 143. For example, the controller 201 receives data including context from the context module 205 and stores the data in the data storage 143 or memory 249. In further implementations, the controller 201 retrieves data from the data storage 143 and sends the data to other components of the autocorrect application 103. For example, the controller 201 retrieves data including a context related to a user from the data storage 143 and sends the data including the context related to the user to the suggestion module 207 for determining a suggested correction. In another example, the controller 201 retrieves data including a history of selected potential errors by a user from the data storage 143 and sends the data including the history of selected potential errors by the user to the adaptive addition module 209 for processing. In another example, the controller 201 retrieves user profile information from the data storage 143 and send the user profile information to the user profile module 213.

The receiver module 203 may be steps, processes, functionalities, or a device to receive content from a user and then send the content to one or more other components of the autocorrect application 103 to perform their respective acts and/or functionalities. In some implementations, the receiver module 203 may be configured to provide an application program interface (API) to a user via the display device 239 to receive content from the user. In further implementations, the receiver module 203 may be configured to receive the content, a portion of the content, or a copy of the content, from another component of the system 100 as part of the process of sharing content. In some implementations, the receiver module 203 may be coupled to the capture device 245 to receive captured information. In some implementations, the receiver module 203 may be configured to receive a file. In some implementations, the receiver module 203 may be configured to receive information related to the content, a context, a user, a database library, etc. and may provide the received information to the other components of the autocorrect application 103.

The context module 205 may be steps, processes, functionalities, or a device for determining a context of the content received by the receiver module 203 and provide the context to one or more other components of the autocorrect application 103 to perform their respective acts and/or functionalities. In some implementations, the context module 205 may receive the content and/or information related to the content, from the receiver module 203 and use the content, or information related to the content, to determine a context of the content. The structure and operation of the context module 205 are described in more detail below with reference to FIGS. 2C and 3C. In some implementations, the context module 205 may determine the context of the content by querying the database library module 211 and comparing the content to a database. In further implementations, the context module 205 may receive information related to the user from the user profile module 213 and use the information related to the user profile to determine the context.

The suggestion module 207 may be steps, processes, functionalities, or a device to determine and provide suggested corrections, such as identifying a potential error and/or providing a suggested correction, to one or more other components of the autocorrect application 103 to perform their respective acts and/or functionalities. In some implementations, the suggestion module 207 may use content received from the receiver module 203 and context received from the context module 205 to generate suggested text or words. In some implementations, the suggestion module 207 may use content received from the receiver module 203 and context received from the context module 205 to determine a suggested correction. In some implementations, the suggestion module 207 may determine suggested corrections by selecting an appropriate database library using the context, and then querying the database library module 211 to access the database library and/or receive information related to the database library from the database library module 211. In further implementations, the suggestion module 207 may monitor a user's interactions with a provided suggested correction and may provide information related to which suggested corrections were used by the user to the adaptive addition module 209 and/or the user profile module 213 so they may use that information for updating. In some implementations, the suggestion module 207 may be coupled to the display device 239 to display the suggestion.

The adaptive addition module 209 may be steps, processes, functionalities, or a device for adaptively updating and adding information to the databases. In some implementations, the adaptive addition module 209 may also provide information to other components of the autocorrect application 103 to perform their respective acts and/or functionalities. In some implementations, the adaptive addition module 209 may receive a user's interactions with a suggested correction from the suggestion module 207 and may update a database based on the interactions. For example, the database may be updated one a correction is used a predetermined number of times by the user. The predetermined number can be any number of one or more. In another example, different databases may be associated with different contexts, corrections may be stored in respective databases depending on the context where the correction was made. In further embodiments, the adaptive addition module 209 may receive information related to a database from the receiver module 203 and may update the database using the information and/or provide the information to the database library module 211.

The database library module 211 may be steps, processes, functionalities, or a device for storing different libraries of information that are used by the other components of the autocorrect application 103 to perform their respective acts and/or functionalities thereon. For example, the database library module 211 may provide databases or portions thereof to the suggestion module 207 that can be used to determine errors, determine possible corrections or determine suggestions based on input data, determined context or both. In some implementations, the database library module 211 performs the comparison or queries using input data or determined context of database information and provides the results. The database library module 211 is coupled for communication and interaction with the other components of the autocorrect application 103 to perform their respective acts and/or functionalities, in particular, the data storage 143, the suggestion module 207, the context module 205 and the receiver module 203. In some implementations, the database library module 211 may receive from the suggestion module 207 content and/or context and may compare the content and/or context to one or more databases. The database library module 211 may then provide the results of the comparison to the suggestion module 207. In further implementations, the database library module 211 may provide access to the database to another component of the autocorrect application 103, such as the suggestion module 207 and/or the context module 205. In some implementations, the database library module 211 may store the databases and in some implementations the database library module 211 accesses databases stored in other components of the system 100.

The user profile module 213 may be steps, processes, functionalities, or a device for to provide information related to the user to other components of the autocorrect application 103 to perform their respective acts and/or functionalities. In some implementations, the user profile module 213 may organize and store information related to a specific user. In further implementations, the user profile module 213 may provide the information related to a specific user to one or more other components of the autocorrect application 103 to personalize the performance of the other components for that specific user. In some implementations, the user profile module 213 may receive information related to a user from the receiver module 203. The information related to the user may include information for determining a context, for example, a primary language of the user, a base location of the user, etc. In further implementations, the user profile module 213 may be configured to provide user profile information to the context module 205 for the context module 205 to determine a context.

Additional structure, acts, and/or functionality of receiver module 203, the context module 205, the suggestion module 207, the adaptive addition module 209, the database library module 211, and the user profile module 213 are further described below with respect to FIGS. 2B-9.

FIG. 2B is a block diagram of an example device 107. As depicted, the example device 107 may include a processor 247, a communication unit 241, a display device 239, a memory 249, a capture device 245, a data storage 143b, and an autocorrect application 103b, which may be communicatively coupled by a communication bus 220. As depicted, the autocorrect application 103b includes a controller 201, a receiver module 203, a context module 205, a suggestion module 207, an adaptive addition module 209, a database library module 211, and a user profile module 213. The function of the components of the autocorrect application 103b depicted in FIG. 2B is similar to the components depicted in FIG. 2A, described elsewhere herein so that description is not repeated here.

FIG. 2C is a block diagram of an example context module 205. As depicted, the example context module 205 may include a location module 215, a language module 217, a profile module 219, a calendar module 221, a communications context module 223, a search module 225, and other information module 227. The components of the example context module 205 may be configured to communicate with other components of the example context module 205 and/or other components of the autocorrect application 103 via the bus 220.

The location module 215 may be steps, processes, functionalities, or a device for determining a location context and sending the location context to other components of the autocorrect application 103 to perform their respective acts and/or functionalities. The location module 215 may receive location data from the receiver module 203. The location data may be captured by one or more sensor(s) of the capture device 245. The sensor(s) may include a geo-location sensor, such as a global position system (GPS), a Wi-Fi connection using an IP address for triangulation, a Bluetooth® low energy device, etc. In further implementations, the location module 215 may access metadata associated with content received by the receiver module 203 in order to determine a location. The location module 215 is coupled to provide this location context to the suggestion module 207 or other modules of the autocorrect application 103.

The language module 217 may be steps, processes, functionalities, or a device for determining a language context of content based on a language and sending the language context to other components of the autocorrect application 103 to perform their respective acts and/or functionalities. In some implementations, the language module 217 may receive language information from the user profile module 213 related to a specific user. In further implementations, the language module 217 may determine a language based on languages present in the content received from the receiver module 203. In other implementations, the language module 217 may determine a language based on location from the location module 215 and a comparison to a table identifying the language dominate in that region or location. The location module 215 is coupled to provide this language context to the suggestion module 207 or other modules of the autocorrect application 103.

The profile module 219 may be steps, processes, functionalities, or a device for determining a profile context of content based on a profile of a user and sending the profile context to other components of the autocorrect application 103 to perform their respective acts and/or functionalities. In some implementations, the profile module 219 may receive profile information related to a specific user from the user profile module 213 and determine the profile context based on the profile information. For example, the profile information may include name, languages spoken, residence information, citizenship, employer, friends, relatives, work address, etc. In further implementations, the profile module 219 may access profile information stored in the data storage 143 (e.g., a profile server, not shown) or a third party application via the network 105.

The calendar module 221 may be steps, processes, functionalities, or a device for determining a calendar context of content based on a calendar and sending the calendar context to other components of the autocorrect application 103 to perform their respective acts and/or functionalities. In some implementations, the calendar module 221 may receive calendar information related to a calendar of a user from the receiver module 203, the user profile module 213, or the database library module 211. For example, one or more calendars of the user may be accessed and information may be retrieved for example from the user work calendar or personal calendar. The calendar information may indicate any event, meetings, appointments, calls special dates (e.g., birthday, anniversary, etc.) and information related to the context of those events such as time, location, attendees, etc. The calendar module 221 may access calendar information stored in memory 249 and/or the data storage 143. In some implementations, the calendar module 221 may send a request to receive information from a third party calendar application and receive the third party calendar application information.

The communications context module 223 may be steps, processes, functionalities, or a device for determining a communication context of content based on a communication type, communication attributes and parties involved, and sending the context to other components of the autocorrect application 103 to perform their respective acts and/or functionalities. In some implementations, the communications context module 223 may be configured to receive content including communications from the receiver module 203 and may determine a context of the communications including attributes including but not limited to type of communication, parties involved in communication, application used for the communication, times available for communication, times not available for communication, presence information, etc. For example, the communication types may include texting, email, video conferencing, etc.

The search module 225 may be steps, processes, functionalities, or a device to determine a search context of content based on a search history and to send the search context to other components of the autocorrect application 103 to perform their respective acts and/or functionalities. In some implementations, the search module 225 may be configured to receive search history from a browser or other source capable of providing a search history. In further implementations, the search module 225 may query a third party search history application or resource for a search history of a user and receive search history data related to a specific user from the third party search history application.

The context module 205 may optionally include the other context information module 227. The other context information module 227 may be steps, processes, functionalities, or a device to determine any other context of content based on other activities of the user whether recorded by the device 107, the server 101 or other resource (not shown). The other context information is sent to the other components of the autocorrect application 103 to perform their respective acts and/or functionalities. The other context information module 227 is coupled to these other sources of context to retrieve and provide any other context of content.

Additional structure, acts, and/or functionality of the location module 215, the language module 217, the profile module 219, the calendar module 221, the communications context module 223, the search module 225 and the other information module 227 are further described elsewhere herein with respect to at least FIGS. 3-8.

FIG. 2D is a block diagram an example database library module 211. As depicted, the example database library module 211 may include a language database 227, a context specific database 229, a business database 231, an image database 233, a search history database 235, a user profile database 237 and a supplemental database 243. The components of the database library module 211 may be configured to communicate with other components of the database library module 211 and/or other components of the autocorrect application 103 via the bus 220. The database library module 211 may also include logic or routines to determine which database to access based on the context input and the data input from the various databases of the database library module 211. In some implementations, the database library module 211 may also include logic or routines to store and retrieve data to and from other databases (not shown) but stored in the memory 249 and/or data storage 143 or accessible via network 105.

The language database 227, the context specific database 229, the business database 231, the image database 233, the search history database 235, the user profile database 237 and the supplemental database 243 are data storage units organized for storing data, retrieving data, and organizing data. The databases 227, 229, 231, 233, 235, 237, and 243 are responsive to write requests and queries. While shown as individual modules, two or more of the databases 227, 229, 231, 233, 235, 237, and 243 may be combined into one database. Each of the databases 227, 229, 231, 233, 235, 237, and 243 stores different information that can be queried to determine if an input is correct or to provide suggestions or substitutions for the input.

The language database 227 includes a dictionary for at least one language. In some implementations, the language database 227 may include a different dictionary for each language and/or each dialect of a language. For example, the language database 227 may include different dictionaries for English, French, Spanish, Japanese, Chinese, etc. The language database 227 allows comparison of the data input against one or more dictionaries to identify errors, corrections or suggestions. The language database 227 is coupled to bus 220 to receive data and instruction and send response data to other components of the autocorrect application 103.

The context specific database 229 is a database that stores a set of information or references to other information stored in other databases or elsewhere. The data in the context specific database 229 is organized or grouped according to a specific context for a particular user. The context specific database 229 may include a plurality of specific contexts or groupings for each user. Further, the context specific database 229 may include the plurality of specific contexts for any number of users greater than one. For example, if a first user is bilingual in two languages, the context specific database 229 for that user may store references to dictionaries or the dictionaries themselves for the two languages. In other words, a data for a context specific to the user is stored in the context specific database 229. Similarly, if the first user also routinely travels between 2 locations like San Francisco and Tokyo, the context specific database 229 for that user may store references to databases for those 2 locations as a second context. Thus, it should be understood that a contact specific database 229 store data from or reference data from the language database 227, the business database 231, the image database 233, the search history database 235, the user profile database 237 and the supplemental database 243 as they related to one or more specific contexts for a particular user. The context specific database 229 is coupled to bus 220 to receive data and instruction and send response data to other components of the autocorrect application 103.

The business database 231 is a database storing business information. For example, any type business information may be stored in the business database 231 for use in identifying errors, corrections and suggestion in input data. For example, the business information may include, but is not limited to, business name, business address, business website address, business owner, business telephone number, business entity type, business or services provided, hours of operation, prices, affiliates, product or service images/photos/videos, website, endorsements, reviews, etc. The business database 231 is coupled to bus 220 to receive data and instruction and send response data to other components of the autocorrect application 103.

The image database 233 is a database storing images. For example, any images may be stored in the image database 233 for use in identifying errors, corrections and suggestion in input data. The images may include various types of meta data and tagging for use by the autocorrect application 103 to locate and use images in from the image database 233. The image database 233 is coupled to bus 220 to receive data and instruction and send response data to other components of the autocorrect application 103.

The search history database 235 is a database of search history of the particular user and may include anonymized search information of other user. For example, search history database 235 may store the search history of the user including search terms, search results, and search context. The search history database 235 may also include anonymized search information of other user to identify trending topics, terms or results, and also similar patterns and likely suggestions based on those patterns. The information from the search history database 235 may be used in identifying errors, corrections and suggestion in input data. The search history database 235 is coupled to bus 220 to receive data and instruction and send response data to other components of the autocorrect application 103.

The user profile database 237 is a database of user profile information of the user. The user profile database 237 may store the profile of the user for the autocorrect application 103. The user profile database 237 may also store the profile(s) of the user from other systems and applications. The user profile database 237 may store information input by the user about her preferences for language, base location, interests, etc. The information from the user profile database 237 may be used in identifying errors, corrections and suggestion in input data. The user profile database 237 is coupled to bus 220 to receive data and instruction and send response data to other components of the autocorrect application 103.

The supplemental database 243 is provided in FIG. 2D to represent other databases and information sources used by the autocorrect application 103 in identifying errors, corrections and suggestion in input data. For example, the supplemental database 243 may be a location data based that provides language preferences based on GPS location, Wi-Fi address or IP address. In another example, the supplemental database 243 may be a geographic databased that specifics language preference by country or region. In yet another example, the supplemental database 243 may include calendar information with information about the events and appoints in the calendar of the user. In another example, the supplemental database 243 may be a dictionary of corrected spellings or alternate spellings preferred by the user. While in other implementations, such additions are added to their respective databases, they may be collected and stored in the supplemental database 243 dedicated for storing them. The supplemental database 243 is shown with dashed lines in FIG. 2D to indicated that it is optional. The supplemental database 243 is coupled to bus 220 to receive data and instruction and send response data to other components of the autocorrect application 103.

Additional structure, acts, and/or functionality of the language database 227, the context specific database 229, the business database 231, the image database 233, the search history database 235, the user profile database 237 and the supplemental database 243 are further described elsewhere herein with respect to at least FIGS. 3A-9.

### Methods

FIG. 3A is a flowchart illustrating an example method for automatically generating spelling suggestions and corrections. In some implementations, a user may create content, the content may be any digital media created or captured by the user. Examples of content may include, a text message, an audio message, a video, an image, an e-mail, a document, a file, a blog, a post or update on a web application, etc. The method 300 begins at block 301 by receiving content that the user intends to share or transmit. Sharing the content may include allowing the content to be viewed by another user. Examples of sharing the content may include, sending the content to another specific user, publishing the content to a social media platform, publishing the content to a web application, etc. The receiver module 203 receives content being shared by the user. In one example, the content being shared by a user is a text message.

Referring now also to FIG. 3B, an example method 301 for receiving content being shared by a user is shown. It should be understood that only one of the blocks 321-329 of FIG. 3B is necessary so that is why they are depicted in dashed lines, because one or more of they may be optional. At block 321, the receiver module 203 may receive an image. The image may be an image being shared by the user with another user, an image being posted to a web application via the network 105, an image being sent as an e-mail attachment, etc. At block 323, the receiver module 203 may receive an audio file. The audio file may be an audio message sent to another user, an audio message posted to a web application via the network 105, etc. At block 325, the receiver module 203 may receive text based content, for example, a text message, an email message, a blog post, etc. At block 327, the receiver module 203 may receive a video file. The video file may be a video being shared with another user, a video being posted to a web application via the network 105, etc. At block 329, the receiver module 203 may receive other information. For example, meta data, an icon or any other information the user wants to share with other may be received by the autocorrect application 103.

Referring back to FIG. 3A, at block 303, the method 300 determines 303 the language associated with the content received in block 301. In some implementations, the method 300 may determine the language associated with the content by determining a default language for the user and using that default language. In some implementations, the method 300 may determine the language associated with the content by determining a default language for the device 107 and using that language. In some implementations, the method 300 may parse the content to determine clues or an associated language and use that language. The method 300 then determines 305 whether the user's consent to use her context information has been received. If not, the method 300 proceeds to determine potential errors and corrections in the content using a dictionary for the language determined in block 303 before proceeding to block 311.

On the other hand, if in block 305 the consent of the user to use her context information has been received, the method continues in block 307. In block 307, the method 300 determines the context of the content. The context module 205 determines a context of the content received by the receiver module 203. Determining the context may include determining context information related to the content. Context information may include details and characteristics of the content that may be used to identify one or more context database(s) for comparison. A context database may include previously stored data separate from a language database described elsewhere herein. At block 305, the context module 205 may determine the context by processing the content and extracting context information. For example, the context may be a location of the user sharing the content. The location module 215 may determine that the device 107 is located in Japan using geolocation data and a language module 217 may provide a database of Japanese words for the suggestion module 207 to compare the portions of the content in order to identify a suggested correction. Examples of context information that may be identified and/or included in the context database may include, location data (e.g., user location, device location, commonly visited locations, etc.), language data (e.g., language of user, language of location, various dialect languages, etc.), user profile data (e.g., information relevant to a specific user including predetermined settings, privacy controls, native language, language of the language database, etc.), calendar data (e.g., schedule of trips to different locations, common locations of meetings, duration of specific trips, destinations identified in calendar, future trips, etc.), communication context data (e.g., a type of communication, specific words, locations, metadata, etc. included in content or previously shared content that is relevant to a context determination of the content.), and/or search history data (e.g., search history using a search engine, timeline of searches, etc.).

Referring now also to FIG. 3C, an example method 307 for determining a context of content is described. At block 331, the context module 205 may determine a location. In some implementations, the location may be determined by the location module 215 as described elsewhere herein. At block 333, the context module 205 may determine a language. In some implementations, the language may be determined by the language module 217 as described elsewhere herein. At block 335, the context module 205 may determine profile information. In some implementations, the profile information may be determined by the profile module 219 as described elsewhere herein. At block 337, the context module 205 may determine calendar information. In some implementations, the calendar information may be determined by the calendar module 221 as disclosed elsewhere herein. At block 339, the context module 205 may determine search history information. In some implementations, the search history information may be determined by the search module 225 as disclosed elsewhere herein. At block 341, the context module 205 may determine a communication type. The communication type may include a type of communication through which the user is sharing the content, such as a text message, a blog, a post to a web-application, an e-mail, etc. In some implementations, the communication type may be included as part of the context of a communication. In further implementations, the communication type and/or context of the communication may be determined by the communication context module 223 as disclosed elsewhere herein. At block 343, the context module 205 may determine context from one or more of the above determinations. In some implementations, the context module 205 may receive one or more of the above determinations to make an overall context determination. In some implementations, the context module 205 may use the one or more above determinations to query via the database library module 211 one or more databases related to the determinations.

Referring back to FIG. 3A, at block 309, the method 300 determines or confirms a potential error or a correction for the content using the language determined in block 303 and a context determined by the context module 205 in block 307. Potential errors may include a difference between a portion of the content and information included in a language database as discussed elsewhere herein. Examples of potential errors may include, a misspelled word, a grammatical error, an incorrect location identification, an incomplete portion of content (e.g., a missing instruction set, incorrectly formatted, etc.), etc. In some implementations, the suggestion module 207 may parse the content and compare portions of the content to a database provided by the database library module 211 based on the context. For example, the suggestion module 207 may compare the potential error to database of Japanese words to determine if the potential error is present in that database. If it is present, it is not an error, but if it not in the database of Japanese words, it is confirmed potential error.

In some implementations, the method 300 determines if the potential error is a contextual error. Contextual errors may include a difference between a portion of the content (e.g., the potential error) and information included in the context database as discussed elsewhere herein. For example, contextual errors may include words spelled in a different language, locations in a different location, a grammatical or formatting difference based on a specific context, etc. In some implementations, the contextual error may be referred to as the confirmed potential error where the potential error is present after the comparison to the language database as well as the comparison to the context database.

In further implementations, the method 300 may identify and provide a suggested correction for the potential error or the confirmed potential error. The suggested correction may include an entry in the contextual database that is similar to the contextual error. In some implementations, the similarity between the suggested correction and the contextual error may be a predefined threshold value for the amount of differences between the suggested correction and the contextual error. The predefined threshold value may be a weighted value that assigns different weights to differences between the suggested correction and the contextual error. Suggested corrections may include correct spellings for words in different languages, contextually correct locations (e.g., name of a location, directions to a location, proper names, etc.), a grammatical or formatting correction based on the context, etc.

At block 311, the suggestion module 207 may provide the potential error and/or a suggested correction to the user on a display device 239. In some implementations, the display device 239 may display the suggested correction in a graphical user interface for the user. In further implementations, the suggestion module 207 may observe user interaction to detect whether the user selects the suggested correction to replace a portion of the content. In one example, the suggestion module 207 may provide a suggested correction for a proper noun in Japan that the user spelled incorrectly in the content. After the user selects the proper noun, the suggestion module 207 may provide the selected information to the adaptive addition module 209 and the adaptive addition module 209 may update one or more databases in the database library module 211 based on predefined conditions being met. For example, the adaptive addition module 209 may add the proper noun to the language database in response to the proper noun correction being selected more than once. In other examples, the adaptive addition module 209 may use machine learning to automatically determine when databases needs to be updated and content moved from one database to another.

In some implementations, the adaptive addition module 209 may determine future contexts. The future contexts may be determined using machine learning and may include potential locations the user may be at or potential databases that the user may use based on a future condition. For example, the adaptive addition module 209 may receive calendar information indicating that the user will be going on a trip to Japan in two weeks. The adaptive addition module 209 may preload the Japanese language database into the context specific database 229 and/or the language database 227 in some implementations. By preloading the database, the speed of corrections and ability to identify potential errors may be increased. In some implementations, the adaptive addition module 209 may preload the databases onto the device 107 to reduce processing time.

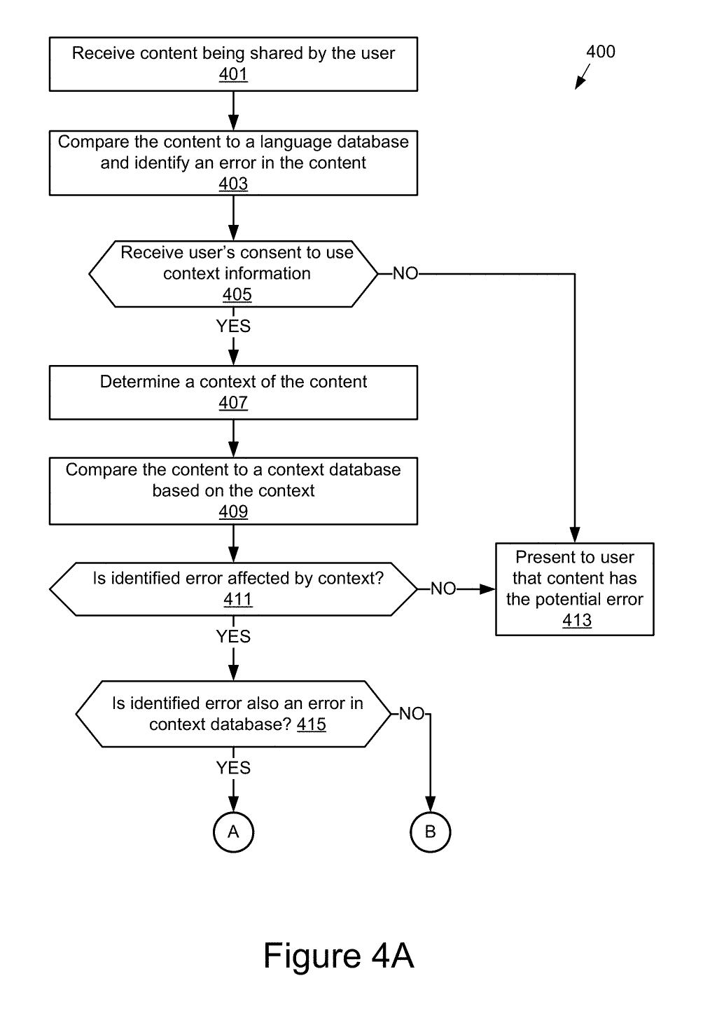

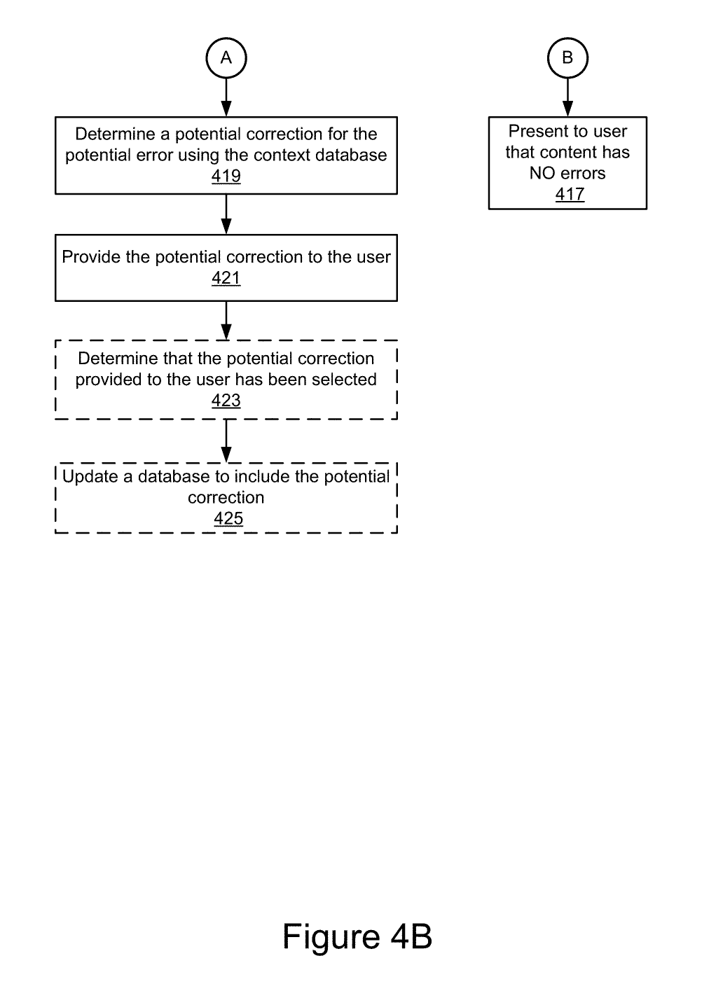

FIGS. 4A-4B are another example method 400 for providing a suggested correction to the user. The method 400 begins with the receiver module 203 receiving 401 content being shared by the user. In some implementations, the receiver module 203 may receive the content and pass the content to the suggestion module 207. In one example, the received content may be an image. At block 403, the suggestion module 207 receives the content and compares the content to a language database 227. At block 403, the suggestion module 207 may also identify a potential error in the content. In some implementations, the database library module 211 may provide access to the language database 227 to the suggestion module 207. The suggestion module 207 may compare the content, or a portion of the content, to the items included in the language database 227. The suggestion module 207 may identify the content, or portions of the content, that are not included in the language database 227 as potential errors. In further implementations, the suggestion module 207 may identify items included in the language database that are similar to the potential errors and may provide those identified items as suggested corrections based on the language database. In one example, the content may include an image and the suggestion module 207 may compare the image to a database of images to determine that the image, or a portion of the image is present in a standard database. If it is present in the data base, the metadata associated with the image in the database is then used to identify error and provide suggested corrections.

The method 400 then determines 405 whether the user's consent to use her context information has been received. If not, the method 400 proceeds to block 413 to present that the content has an error or provide a suggested correction. At block 413, the method 400 may provide the error identified in block 403.

However, if in block 405 the method 400 determined that the user's consent to use her context information has been received, the method proceeds to block 407.

At block 407, the context module 205 determines a context of the content. The context module 205 may determine a context of the content by determining contextual information related to the content using the components of the context module 205. In some implementations, the context module 205 may determine location data using the location module 215. The location module 215 may determine the location data by receiving information from the receiver module 203 related to the location as discussed herein. In some implementations, the location module 215 may use processing techniques on the input content to identify objects in the content. For example, the content may be an image and the location module 215 may identify objects (e.g., historical landmarks, points of interest, well know structures) in the image or related to location data in the image using image processing techniques. Additionally, the language module 217 may identify a language based on the objects identified in the image (e.g., the language may be determined to be French if the object identified is the Eiffel Tower). Similarly, the context module 205 may determine location data using the language module 217. The language module 217 may process the content to identify objects related to a language. In one example, the language module 217 may process a string of text and identify a language that uniquely corresponds to that text. The language may be then translated into areas or regions where the identified language is the dominant language for that area or region.

In some implementations, the context module 205 may determine profile data related to the profile of a user cooperating with the profile module 219. The profile module 219 may determine profile information by parsing the content and identifying portions of the data related to user profiles. The portions may be identified by comparing words included within the content that correspond to predefined words related to user profiles. In some implementations, the context module 205 may determine calendar data using the calendar module 221. The calendar module 221 may receive data from a calendar application and may parse the calendar data to identify information for determining context. For example, the calendar module 221 may receive a calendar schedule of a user and identify a trip and/or a location of the trip that the user is currently on. In some implementations, the search module 225 may receive information related to a search history of the user and parse the search history to identify context information, such as languages, locations, calendar data, profile information, etc.

In some implementations, the communication context module 223 may determine the context of a communication by identifying historical communications related to the content. For example, the content may be a text message and the communications context module 223 may identify other text messages related to the content or the same topic or recipients and senders. The communication context module 223 may parse the other text messages for context information, such as topics, senders, recipients, languages, locations, calendar data, profile information, etc. In some implementations, the communication context module 223 may determine the context of a communication by determining the type of communication, such as a text, an audio message, a video file, etc.

At block 409, the suggestion module 207 compares the content to a context database based on the context. In some implementations, the suggestion module 207 may receive the content from the receiver module 203 and the context from the context module 205. In some implementations, the database library module 211 may provide the suggestion module 207 access to a specific database based on the context. Additionally, the database library module 211 may provide access to the context specific database 229. The suggestion module 207 may compare the content, or a portion of the content, to the items included in the context specific database 229 or other databases of the database library module 211.

At block 411, the suggestion module 207 may determine whether the identified potential error is affected by context. For example, the error is not affected by context if the identified potential error is: 1) an error both in the language database and the database(s) identified by context, and/or 2) the database(s) identified by context provide no different suggested corrections than the language database. If the identified potential error is not affected by context, the method 400 continues at block 413 where the suggestion module 207 may present to the user that the content includes the potential error. In block 413 where the suggestion module 207 may present the error identified in block 403. The suggestion module 207 may present to the user that a potential error may be present by providing an indication associated with a word on a graphical user interface displayed on the display device 239.

If in block 411 the identified potential error is affected by context, the method 400 continues at block 415 with the suggestion module 207 determining whether the potential error is also an error in the database(s) identified by context (also referred to below as the “context database”). In some implementations, the suggestion module 207 may determine that the potential error is also an error in the database(s) identified by context by determining if the potential error is present in a context specific database 229 provided by the database library module 211 based on the context. For example, a Japanese proper noun shared as part of the content may not be present in the language database for the English language; however, the Japanese proper noun may be present in a Japanese language database that is accessed based on the context being a Japanese location.

If the method 400 determined in block 415 that the identified error from block 403 is not an error based on context, then the method 400 continues in block 417 of FIG. 4B. At block 417, the suggestion module 207 may present to the user that the content has no errors in response to determining that the identified error from block 403 is not an error in the applicable database(s) identified by context. The suggestion module 207 may determine that the content has no errors based on a comparison of the potential error to the items of the context specific database 229 and identifying an item in a context specific database 229 that is the same, and/or similar enough to the potential error to be considered a match. For example, a user may use the Japanese proper noun, Meiji Shrine, which may not be present in the English language database, but may be present in a context specific database 229 or a Japanese language database identified from context that includes Japanese proper nouns. This example illustrates how content that would include a potential error if only the language database was used for autocorrection, is marked as correct to the user after comparing to a context database automatically without requiring the user to manually switch databases.

If the method 400 determined in block 415 that the identified error from block 403 may be an error based on context as well, then the method 400 continues in block 419 of FIG. 4B. At block 419, the suggestion module 207 may determine a suggested correction for the potential error using the applicable database(s) identified by context. In some implementations, the suggestion module 207 may determine a suggested correction by identifying one or more items included in the context database that are similar to the potential error. For example, the user may include in the content the word “Mayge” and the suggestion module 207 may determine using the context database that the Japanese proper noun “Meiji” may be a suggested correction based on an image being shared of the Meiji Shrine located in Japan or phonetics. In some implementations, the suggestion module 207 may determine a suggested correction by determining a phonetic spelling of a word, common misspellings and/or other mistakes based on the context, similar items that meet a predefined threshold of differences compared to the potential error, etc.

At block 421, the suggestion module 207 may provide the suggested correction to the user. In some implementations, the suggestion module 207 may provide the suggested correction by providing an indication of the potential error and/or one or more selectable suggested corrections in a graphical user interface via the display device 239. For example, the suggestion module 207 may highlight the potential error “Mayge” in a visually distinct manner, and provide the suggested correction “Meiji” to the user that user can select. In other implementations, the suggestion module 207 may automatically substitute the potential error with the suggested correction.

At block 423, the suggestion module 207 may determine that the suggested correction provided to the user has been selected. In some implementations, the suggestion module 207 may note the presentation of the suggested correction and provide information to the adaptive addition module 209 related to whether or not the suggested correction was selected by the user. At block 425, the adaptive addition module 209 may update a database (e.g., the supplemental database 243) to include the correction in response to the user selecting the suggested correction. In some implementations, the adaptive addition module 209 may update the database based on pre-defined criteria, such as the suggested correction being selected a threshold amount of times, a suggested correction being selected in a specific time period, etc.

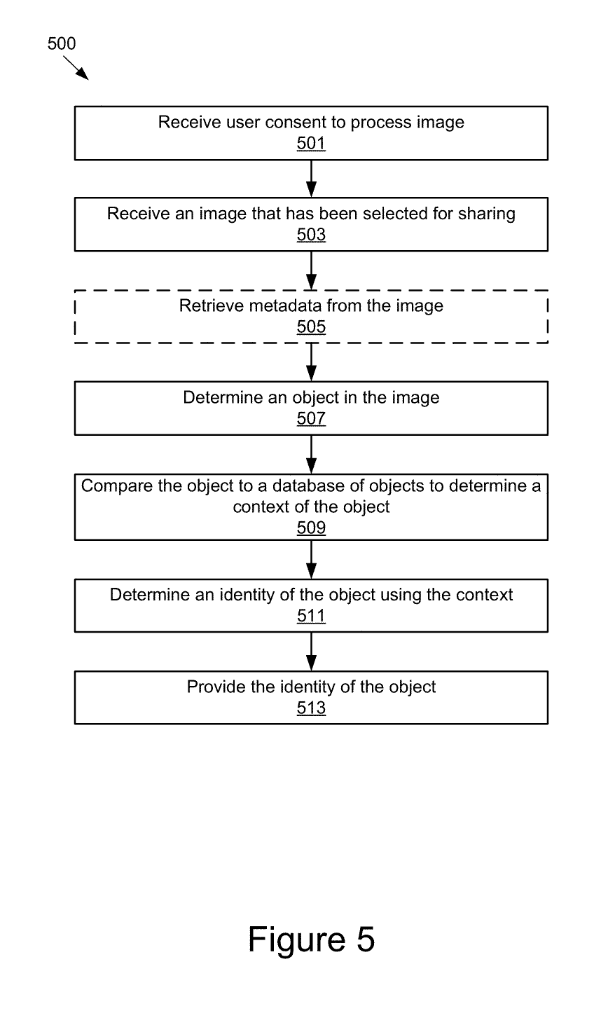

FIG. 5 is an example method 500 for processing an image to determine context or objects. The method 500 begins by receiving user consent to process an image. If consent is not provided, the method 500 ends. If consent is provided, the method 500 continues by receiving 503 an image, content, that has been selected for transmission. For example in block 503, the receiver module 203 may receive an image file that has been selected for sharing by the user. At block 505, the context module 205 may retrieve metadata from the image file. The metadata may include a location, a timestamp, a photographer identity, camera setting when the image was captured, identities of individuals within the picture, etc. This block 505 is shown with dashed lines in FIG. 5 to indicate that it is optional.

At block 507, the context module 205 may determine an object in the image file. The context module 205 may determine an object in the image using image processing techniques. In some implementations, the image processing techniques may be refined based on the context and provide guidance of objects that may be found in the image. For example, the context module 205 may identify a location in Japan where the image was captured. The context module 205 may use the Japanese location to identify objects such as signs, structures, landmarks iconic fixtures, and/or text within the image using the standard image processing techniques to provide further context of the object.

At block 5097, the context module 205 may compare the determined object to a database of objects to determine a context of the object. In some implementations, the database of objects may be the context database provided by the context specific database 229. In some implementations, the database of objects may be the image database 233. The context module 205 may compare the determined object to the database of objects to identify objects similar to the determined object. At block 511, the context module 205 may determine an identity of the object using the context. In some implementations, the identity of the object may be included in the database of objects. At block 513, the context module 205 may provide the identity of the object to one or more other components of the autocorrect application 103.

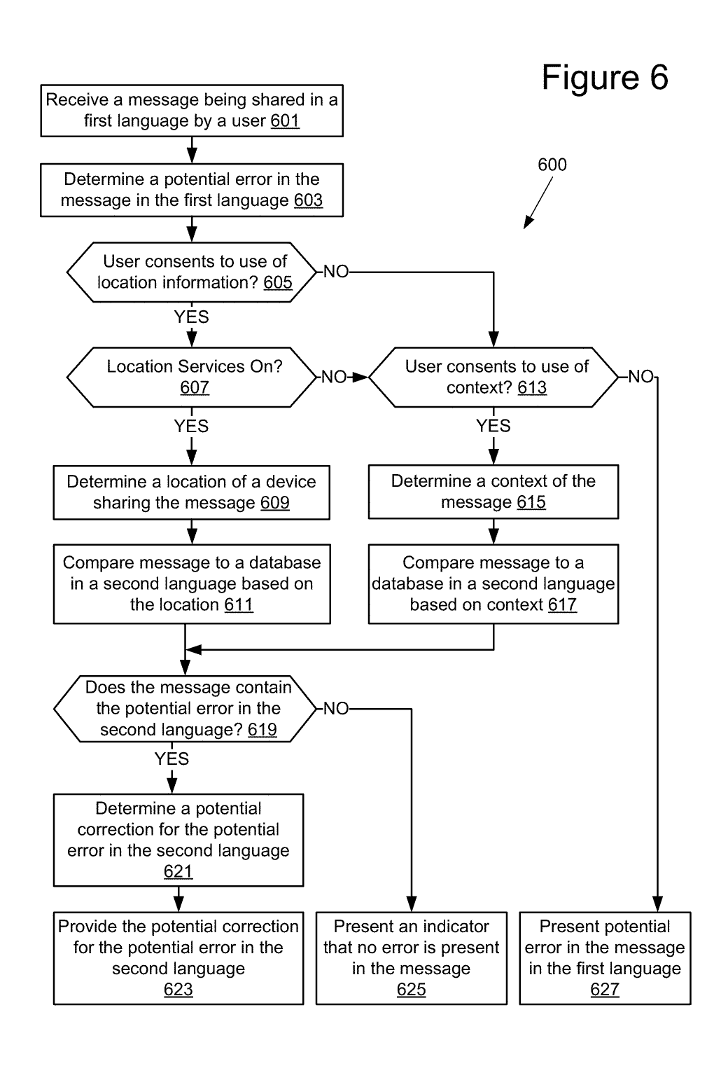

FIG. 6 is another example method 800 for automatically generating spelling suggestions and corrections using location and context. FIG. 6 shows a specific example in which a first language, location and context are used to identify potential errors and possible suggestions or corrections. At block 601, the receiver module 203 may receive a message being shared in a first language by a user. The first language may be a native language of the user, a language based on a country or region, a dialect or accent of a language, etc. In some implementations, the user profile module 213 may identify a predetermined language for the user and the first language may be the predetermined language. For example, the message may be a text message to another user in English saying “I'm visiting the Meiji Shrine while I'm in Japan.” In some implementations, the receiver module 203 may receive the message from the user as the user creates the content. In some implementations, the receiver module 203 receives the message after the user completes creation of the message and before the message is shared with another user.

At block 603, the suggestion module 207 may determine a potential error in the message in the first language. The suggestion module 207 may determine the potential error by comparing the message to a database or dictionary of words in the first language. A potential error may be a portion of the message that does not match with a similar word in the database of words in the first language. With reference to the above example, the word “Meiji” included in the message may not match with a database of words in the English language and the suggestion module 207 may identify the word “Meiji” as a potential error.

At block 605, the context module 205 may determine whether the user has provided consent to use his location information. If not, the method 600 will not use his location information and proceeds to block 613 as will be described below. If the user has provided consent to use his location information, the method 600 proceeds to block 607.

At block 607, the method 600 determines whether location services are turned on or operational. In some implementations, the location services may be location services on the device 107 sharing the message. In some implementations, the location services may be received from a third party application identifying a location of the user. A user may turn location services on and consent to provide the location data using the location services. With reference to the above example, the user may use the device 107 with location services turned on and the location data provided by the location services may indicate that the device 107 is located in Japan or a specific location in Japan. If in block 607, the method 600 determines that location services are not turned on, the method 600 proceeds to block 613 as will be described below. On the other hand, if in block 607 the method 600 determines that location services are turned on, the method 600 proceeds to block 609.

At block 609, the context module 205 may determine a location of the device 107 using the location data. At block 611, the suggestion module 207 may compare the message to a database in a second language based on the location received from the location data. In some implementations, the second language database may be a database in a specific language based on the location data. In some implementations, the database may be in a specific dialect of a specific language based on the location data. With reference to the above example, the device 107 is located in Japan based on the location data and the contents of a Japanese language database may be compared to the message. After block 611, the method continues at block 619.

The method 600 may proceed to block 613 from either block 605 if no consent to use location was provided by the user or from block 607 if location services are not available. At block 613, the method 600 determines whether the user has provided consent to use his context information. If not, the method 600 will not use his context information and proceeds to block 627 where the potential error in the message identified in block 603 based on the first language is provided to the user, for example, displayed on the display device 239. If the user has provided consent to use his context information, the method 600 proceeds to block 615.

At block 615, in response to the location services being turned off or lack of consent to use location information, the context module 205 may determine a context of the message. The context module 205 may determine 615 the context of the message using one or more of the components of the context module 205, discussed above. For example, the context module 205 may parse the message and identify that another user asked if the user was in Japan for the week. Using that communication context, the context module 205 may determine that the context includes the user being located in Japan.

At block 617, the suggestion module 207 may compare the message to a database in a second language based on the context of the message as determined in block 615. With reference to the above example, the suggestion module 207 may compare the message, or portions of the message, to the contents of a Japanese language database based on the context module 205 identifying a context as Japan.

After block 611 or 671, the method 600 continues in block 619. The suggestion module 207 may determine 619 whether the message has a potential error in the second language. The suggestion module 207 may determine that the message contains the potential error in the second language if the contents of the second language database do not match, or similarly match.

If the message is found to include an error in the second language in block 619, the method 600 continues to block 621. At block 621, the suggestion module 207 may determine a suggested correction for the potential error in the second language. The suggestion module 207 may determine a suggested correction by identifying contents of the second database that are similar to the potential error. Similarities may be identified based on the phonetic spelling of the potential error compared to the phonetic spelling of the contents of the database, commonly misspelled words in the second language, grammar mistakes, etc.

At block 623, the suggestion module 207 may provide the suggested correction for the potential error in the second language. In some implementations, the potential error in the second language may be referred to as the context error. The suggestion module 207 may provide the suggested correction for the user to compare to the potential error in the message and change the potential error as desired. In some implementations, the suggested correction may be selectable by the user to replace the potential error. In some implementations, the suggested correction may automatically replace the potential error. With reference to the above example, the suggestion module may provide the suggested correction “Meiji” to replace the potential error “Mayge” and the user may select the suggested correction.

If the message does not include an error in the second language in block 619, the method 600 continues to block 625. At block 625, the suggestion module 207 may present to the user an indication that no error is present in the message. In some implementations, the suggestion module 207 may alternatively present to the user an indication when a potential error is present and present no indication when no potential errors are present. In further implementations, the suggestion module 207 may present to the user an indication when the potential error is determined in the first language and remove the indication after determining that the potential error is not a contextual error based on the comparison to the second language database.

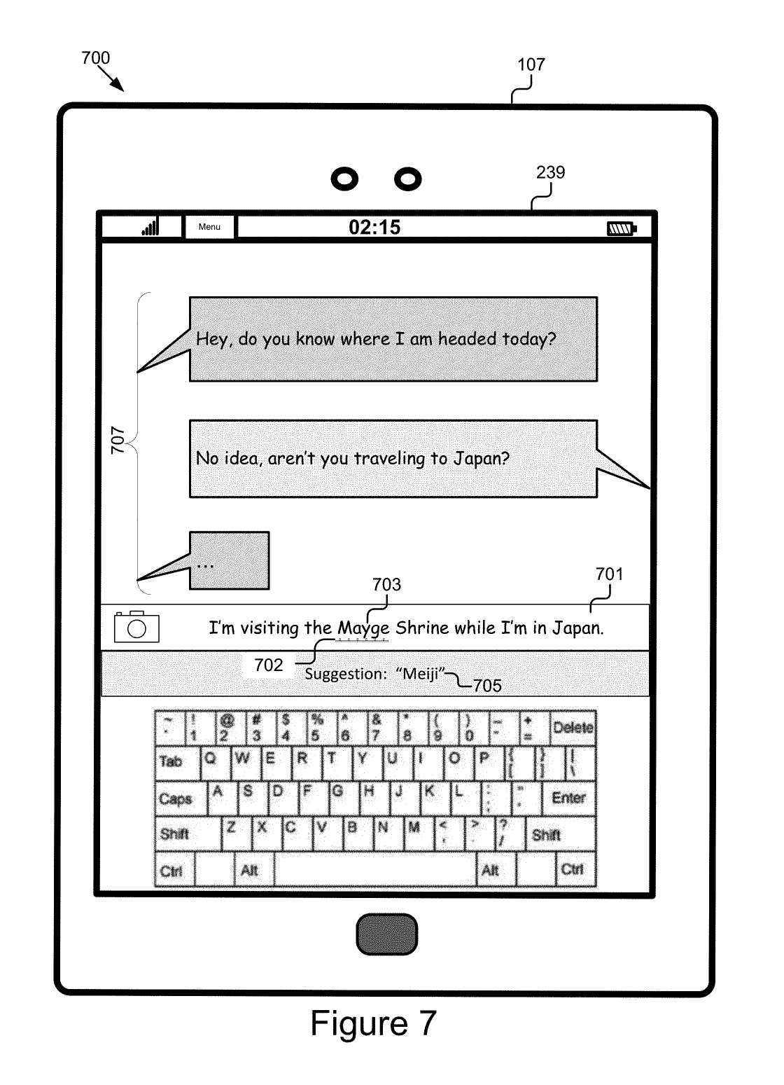

FIG. 7 is a graphical representation 700 illustrating an example of providing a suggested correction for an example text message 701. FIG. 7 displays an example device 107 displaying a graphical user interface being used by the user to send or share text messages. Previously sent or received text messages 707 are displayed on the display device 239 and may be used in some implementations by the context module 205 to determine a communication context. Example text message 701 is content being created for sharing by the user. The example text message 701 includes a potential error 703, “Mayge,” that was not recognized in the English language database. An indication 702 (highlighting by underlining with dots) is displayed that indicates to the user that the potential error 703, “Mayge,” is not present in the English language database. I should be understood that a variety of other indicators that show the potential error in a visually distinct matter, for example, color, font, shading, highlighting, size, capitalization, etc. could be used in addition to or in place of the indicator 702 depicted in FIGS. 7-9. A suggested correction 705 “Meiji” is displayed to the user using the graphical user interface. In some implementations, the user may select the suggested correction 705, “Meiji,” and replace the potential error 703, “Mayge,” present in the example text message 701.

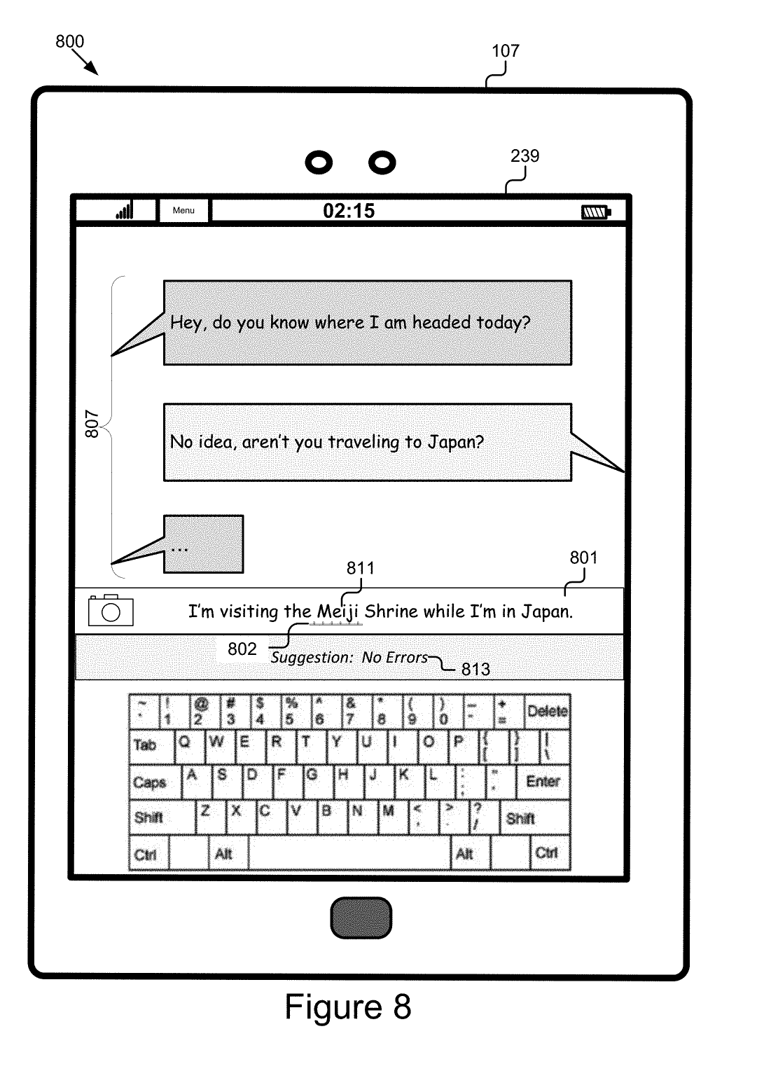

FIG. 8 is a graphical representation 800 illustrating that no error is present for an example text message 801. FIG. 8 displays an example device 800 displaying a graphical user interface being used by the user to share text messages. Previously sent text messages 807 are displayed on the display device 239 and may be used in some implementations by the context module 205 to determine a communication context. Example text message 801 is content being created for sharing by the user. The example text message 801 includes a potential error 811, “Meiji,” that was not recognized in the English language database. An indication 802 is displayed that indicates to the user that the potential error 811, “Meiji,” is not present in the English language database. An indication 813 is displayed to the user in the graphical user interface that no errors are present because the potential error 811, “Meiji,” is present in a context database even though it is not in the English language database. In some implementations, the indication 802 may be removed from display entirely upon the determination that the potential error 811, “Meiji,” is present in the context database, and thus not an error when the context is considered.

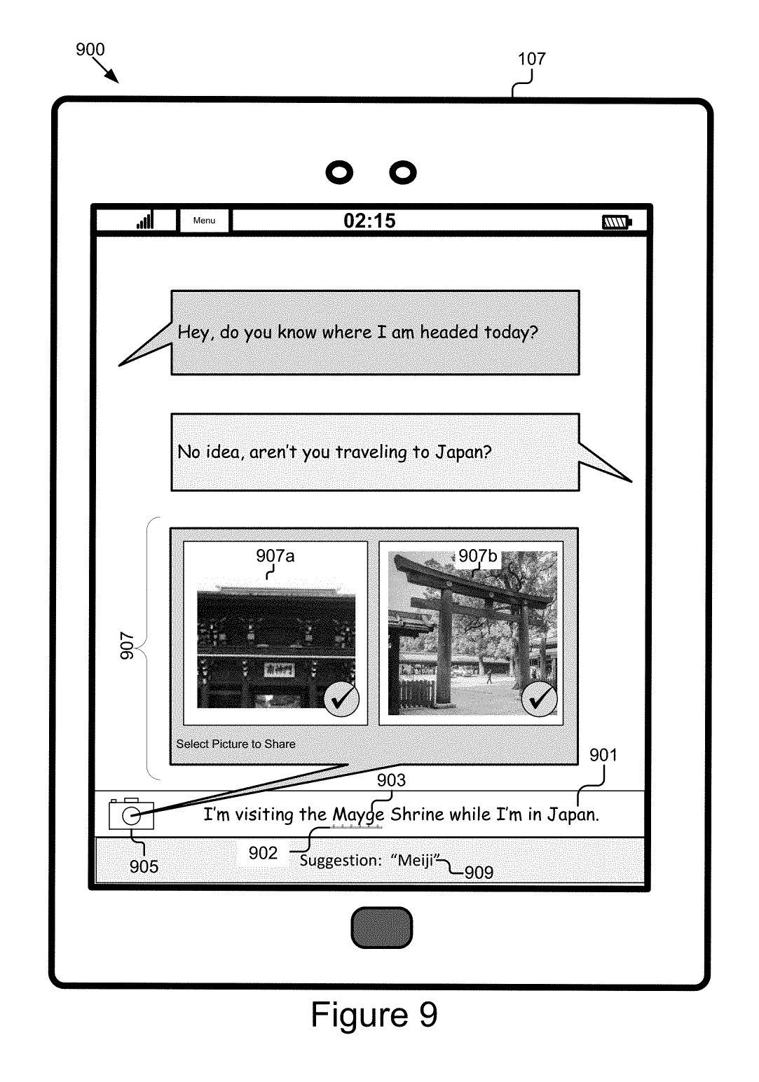

FIG. 9 is a graphical representation 900 illustrating providing a suggested correction 909 for an example text message 901. FIG. 9 displays an example device 107 displaying a graphical user interface being used by the user to share text messages and images. In some implementations, a selectable icon 905 in the shape of a camera may be present in the graphical user interface that the user may select to share images. Images 907a and 907b have been selected for sharing by the user. In some implementations, the context module 205 may identify an object in one or more of the images 907 and use the object to identify a context of the images and/or the communication context as described elsewhere herein. For example, the context module 907 may identify that the images being shared are of the Meiji Shrine in Japan and use that information to access a Japanese language database that includes proper nouns and/or tourist destinations. The example text message 901 includes a potential error 903, “Mayge,” that was not recognized in the English language database. An indication 902 is displayed that indicates to the user that the potential error 903, “Mayge,” is not present in the English language database. A suggested correction 909, “Meiji,” is displayed in the graphical user interface to the user. In some implementations, the user may select the suggested correction 909, “Meiji,” and replace the potential error 903, “Mayge,” present in the example text message 901.

Reference in this specification to “some implementations” or “an implementation” means that a particular feature, structure, or characteristic described in connection with the implementation is included in at least some instances of the description. The appearances of the phrase “in some implementations” in various places in the specification are not necessarily all referring to the same implementation.

In situations in which the systems discussed here may collect personal information about users, or may make use of personal information, users are provided with one or more opportunities as described above to authorize and control whether programs or features collect user information, e.g., information on user actions or activities, user preferences, content created or submitted by a user, or user location. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, a user has control over whether information is collected about the user and, if it is collected, how the information is used by a server.

Some portions of the detailed description are presented in terms of processes and symbolic representations of operations on data bits within a computer memory. These process descriptions and representations are the means used by those skilled in the data processing arts to most effectively convey the substance of their work to others skilled in the art. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The specification also relates to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The specification can take the form of an entirely hardware implementation, an entirely software implementation or implementations containing both hardware and software elements. In some implementations, the specification is implemented in software, which includes but is not limited to firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or social network data stores through intervening private or public networks. Modems, cable modem and Ethernet cards are just a few of the currently available types of network adapters.

Finally, the routines and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the specification as described herein.

The foregoing description of the implementations of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats. Furthermore, as will be apparent to one of ordinary skill in the relevant art, the modules, routines, features, attributes, methodologies and other aspects of the disclosure can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the disclosure is in no way limited to implementation in any specific programming language, or for any specific operating system or environment. Accordingly, the disclosure is intended to be illustrative, but not limiting, of the scope of the specification, which is set forth in the following claims.

1. A computer-implemented method comprising:
receiving, using one or more computing devices, content being shared by a user;
determining, using the one or more computing devices, a first language of the content;
determining, using the one or more computing devices, a context for the content;
determining, using the one or more computing devices, a language error in the first language of the content;
determining, using the one or more computing devices, whether the language error in the first language of the content is a misspelling of a word from a second language based on the context;
responsive to determining that the language error in the first language of the content is the misspelling of the word from the second language, determining, using the one or more computing devices, the language error as a potential error in the content; and
providing, using the one or more computing devices, an identification of the potential error to the user.

2. The method of claim 1, wherein determining the language error as the potential error in the content further comprises:
comparing the content to a first database for the first language to identify the language error in the first language of the content based on the comparison; and
comparing the language error to a context database to confirm that the language error is the potential error.

3. The method of claim 1, further comprising:
determining, using the one or more computing devices, a correction for the potential error based on the first language and the context; and
providing, using the one or more computing devices, the correction to the user in the content in place of the potential error and with the identification.

4. The method of claim 3, further comprising:
determining, using the one or more computing devices, that the correction provided to the user has been selected; and
updating, using the one or more computing devices, the first database to include the correction.

5. The method of claim 1, wherein the content being shared by the user is received from a user device, and wherein determining the potential error in the content further comprises:
determining a location of the user device used to share the content;
determining the second language associated with the location of the user device;
comparing the content to a first database for the first language and identifying the language error in the first language of the content based on the comparison; and
comparing the language error to a second database for the second language and confirming that the language error is also a context error based on the comparison; and
wherein providing the identification of the potential error identifies the language error as the potential error responsive to confirming that the language error is also the context error.

6. The method of claim 1, wherein the content includes an image and determining the context for the content further comprises:
determining an object from the image in the content; and
comparing the object to a database of objects to determine the context.

7. The method of claim 1, wherein the content being shared by the user is received from a user device, and the method further comprises:
determining a future context based on signals received from the user device;
preloading a potential suggestion from the context database and based on the future context to the user device; and
providing, using the one or more computing devices, the potential suggestion to the user in response to receiving future content.

8. A computer program product comprising a non-transitory computer useable medium including a computer readable program, wherein the computer readable program when executed on a computer causes the computer to perform operations including:
receiving content being shared by a user;
determining a first language of the content;
determining a context for the content;
determining a language error in the first language of the content;
determining whether the language error in the first language of the content is a misspelling of a word from a second language based on the context;
responsive to determining that the language error in the first language of the content is the misspelling of the word from the second language, determining the language error as a potential error in the content; and
providing an identification of the potential error to the user.

9. The computer program product of claim 8, wherein the computer readable program when executed on a computer also causes the computer to perform operations including:
comparing the content to a first database for the first language to identify the language error in the first language of the content based on the comparison; and
comparing the language error to a context database to confirm that the language error is the potential error.

10. The computer program product of claim 8, wherein the computer readable program when executed on a computer also causes the computer to perform operations including:
determining a correction for the potential error based on the first language and the context; and
providing the correction to the user in the content in place of the potential error and with the identification.

11. The computer program product of claim 10, wherein the computer readable program when executed on a computer also causes the computer to perform operations including:
determining that the correction provided to the user has been selected; and
updating the first database to include the correction.

12. The computer program product of claim 8, wherein the computer readable program when executed on a computer also causes the computer to perform operations including:
determining a location of the user device used to share the content;
determining the second language associated with the location of the user device;
comparing the content to a first database for the first language and identifying the language error in the first language of the content based on the comparison; and
comparing the language error to a second database for the second language and confirming that the language error is also a context error based on the comparison; and
wherein providing the identification of the potential error identifies the language error as the potential error responsive to confirming that the language error is also the context error.

13. The computer program product of claim 8, wherein the computer readable program when executed on a computer also causes the computer to perform operations including:
determining an object from the image in the content; and
comparing the object to a database of objects to determine the context.

14. The computer program product of claim 8, wherein the computer readable program when executed on a computer also causes the computer to perform operations including:
determining a future context based on signals received from the user device;
preloading a potential suggestion from the context database and based on the future context to the user device; and
providing, using the one or more computing devices, the potential suggestion to the user in response to receiving future content.

15. A system comprising:
one or more processors; and
one or more memories storing instructions that when executed by the one or more processors, cause the system to perform operations including:
receiving content being shared by a user;
determining a first language of the content;
determining a context for the content;
determining a language error in the first language of the content;
determining whether the language error in the first language of the content is a misspelling of a word from a second language based on the context;
responsive to determining that the language error in the first language of the content is the misspelling of the word from the second language,
determining the language error as a potential error in the content; and
providing an identification of the potential error to the user.

16. The system of claim 15, wherein determining the potential error in the content using the first language and the context further comprises:
comparing the content to a first database for the first language to identify the language error in the first language of the content based on the comparison; and
comparing the language error to a context database to confirm that the language error is the potential error.

17. The system of claim 15, wherein the operations further comprise:
determining, using the one or more computing devices, a correction for the potential error based on the first language and the context; and
providing, using the one or more computing devices, the correction to the user in the content in place of the potential error and with the identification.

18. The system of claim 17, wherein the operations further comprise:
determining, using the one or more computing devices, that the correction provided to the user has been selected; and
updating, using the one or more computing devices, the first database to include the correction.

19. The system of claim 15, wherein the content being shared by the user is received from a user device, and wherein determining the potential error in the content using the first language and the context further comprises:
determining a location of the user device used to share the content;
determining the second language associated with the location of the user device;
comparing the content to a first database for the first language and identifying the language error in the first language of the content based on the comparison; and
comparing the language error to a second database for the second language and confirming that the language error is also a context error based on the comparison; and
wherein providing the identification of the potential error identifies the language error as the potential error responsive to confirming that the language error is also the context error.

20. The system of claim 15, wherein the content includes an image and determining the context for the content further comprises:
determining an object from the image in the content; and
comparing the object to a database of objects to determine the context.

21. The system of claim 15, wherein the content being shared by the user is received from a user device, and the operations further comprise:
determining a future context based on signals received from the user device;
preloading a potential suggestion from the context database and based on the future context to the user device; and
providing, using the one or more computing devices, the potential suggestion to the user in response to receiving future content.
